(19) United States
(12) Patent Application Publication
(10) Pub. No.: US 2017/0054746 A1
(43) Pub. Date: Feb. 23, 2017

(54) IDENTIFYING UNVERIFIED APPLICATION BEHAVIOR IN A COMPUTING ENVIRONMENT

(71) Applicant: defend7, Inc., Mountain View, CA (US)

(72) Inventors: Vibhav Sreekanti, Pleasanton, CA (US); Gaurav Mathur, Palo Alto, CA (US); Richard Spillane, Mountain View, CA (US); Gordon Chaffee, Hillsborough, CA (US)

(21) Appl. No.: 15/229,420

(22) Filed: Aug. 5, 2016

Related U.S. Application Data
(60) Provisional application No. 62/206,431, filed on Aug. 18, 2015.

(51) Int. Cl. H04L 29/06

(52) U.S. Cl. CPC H04L 63/1425; H04L 63/20

(57) ABSTRACT

Systems, methods, and software provided herein identify unverified behavior in an application component environment. In one example, a method of operating a collection service includes receiving communication data for a plurality of application components and generating a baseline set of communication interactions for the application component environment based on the communication data. The method further includes receiving additional communication data for the application components and generating a second set of communication interactions for the application component environment based on the communication data. The method also provides identifying a differential set of communication interactions by comparing the baseline set and the second set of communication interactions.

### RELATED APPLICATIONS

This application claims the benefit of, and priority to, U.S. Provisional Patent Application No. 62/206,431, entitled “IDENTIFYING UNVERIFIED APPLICATION BEHAVIOR IN A COMPUTING ENVIRONMENT”, filed Aug. 18, 2015, which is hereby incorporated by reference in its entirety for all purposes.

### TECHNICAL FIELD

Aspects of the disclosure are related to monitoring computing environments and in particular to identifying unverified application behavior.

### TECHNICAL BACKGROUND

An increasing number of data security threats exist in the modern computerized society. These threats may include viruses or other malware that attack the local computer of the end user, or sophisticated cyber-attacks to gather data and other information from the cloud or server based infrastructure. This cloud or server based infrastructure includes physical and virtual computing devices that are used to provide a variety of services to user computing systems, such as data storage, cloud processing, web sites and services, amongst other possible services. To protect applications and services, various antivirus, encryption, and firewall implementations may be used across an array of operating systems, such as Linux and Microsoft Windows.

In some examples, an organization may employ a plurality of application or service components, such as front-end components, back-end components, data storage management components, or any other similar component as part of an overarching application. These components may each operate as a physical computing system, or as virtual computing node alongside one or more other components on the same physical host. However, as more components are added to the system, it may become difficult for an administrator to track the behavior of the various components, as well as the host computing systems on which the components may reside.

### OVERVIEW

Provided herein are systems, methods, and software to identify unverified operational behavior in a computing environment. In one example, a computer readable storage medium having instructions stored thereon that, when executed by a collection service system, direct the collection service system to perform a method of identifying unverified behavior in a computing environment. The method includes receiving a plurality of reports representing communication data for communications by a plurality of application components, and generating an approved set of communication interactions for the plurality of application components based on the communication data. The method also provides receiving one or more additional reports representing supplemental communication data for additional communications by the plurality of application components, and identifying a second set of communication interactions for the plurality of application components based on the supplemental communication data. The method further includes determining a differential set of communication interactions by comparing the approved set of communication interactions and the second set of communication interactions.

In another example, a method of operating a collection service to identify unverified communication interactions for a plurality of application components includes receiving a plurality of reports representing communication data for communications by the plurality of application components, and generating an approved set of communication interactions for the plurality of application components based on the communication data. The method further includes receiving one or more additional reports representing supplemental communication data for additional communications by the plurality of application components, and identifying a second set of communication interactions for the plurality of application components based on the supplemental communication data. The method also provides determining a differential set of communication interactions by comparing the approved set of communication interactions and the second set of communication interactions.

In another instance, a method of operating a collection service to identify unverified behavior in a computing environment includes receiving a plurality of reports from agents in the computing environment, wherein the reports comprise communication data and processing data for application components and host computing systems in the computing environment. The method further includes generating an approved set of behavior operations based on the reports, and receiving one or more additional reports from the agents in the computing environment, wherein the one or more additional reports comprise supplemental communication data and supplemental processing data for the application components and the host computing systems in the computing environment. The method also provides identifying a second set of behavior operations based on the additional reports, and determining a differential set of behavior operations by comparing the approved set of behavior operations and the second set of behavior operations.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment for reporting communication information to a collection service.

FIG. 2 illustrates an analysis process in a collection service to visually represent the communication interactions in a computing environment.

FIG. 3 illustrates a user interface to present a visual representation of a computing environment according to one example.

FIG. 4 illustrates a visual representation 410 of communication interactions for a computing environment.

FIG. 5 illustrates a method of operating a collection service to identify a differential set of communication interactions for a computing environment.

FIG. 6 illustrates an overview of comparing approved communication interactions with secondary communication interactions according to one example.

FIG. 7 illustrates an overview of generating communication interactions sets for a computing environment according to one example.

FIG. 8 illustrates a collection service system according to one example.

### TECHNICAL DISCLOSURE

Internet services rely extensively on security to prevent unpermitted processes and users from accessing sensitive data. Such data may include usernames, passwords, social security numbers, credit card numbers, amongst other sensitive data. To prevent the unpermitted access, firewalls, antiviruses, and other security processes may be executed on the devices hosting the computing services. These security processes are designed to prevent improper access, or mitigate the effects once a breach has occurred.

In some examples, multiple application components may be necessary to provide specific services to an organization, such as front-end components, back-end components, data service components, administrative components, or any other component. Each of these components are responsible for a particular task, such as taking in and storing data, processing data that is received, organizing data received, or any other task necessary for the service. These application components may be implemented on one or more computing devices and processing systems configured by an administrator to perform the associated service.

In the present example, a plurality of application components may be deployed in a computing environment to provide processes required by an organization. These application components may each comprise a physical computing system, a Linux container, jail, partition, or other type of containment module, a full operating system virtual machine, or some other containment system, including combinations thereof. Here, in addition to the application components, a collection service may be provided that is accessible by one or more administrators of the computing environment. This collection service communicates with agents associated with the application components to identify communication data for the components in the environment. This communication data may include the components involved in each communication, the type of communication protocol used for each communication, such as Hypertext Transfer Protocol (HTTP), Secure Sockets Layer (SSL), File Transfer Protocol (FTP), or some other communication protocol, the type of security involved in each communication, the amount of data communicated in each communication, the timestamp for each communication, or some other type of communication information.

Once the communication information is identified, each of the agents communicates the information, as reports, to the collection service. Here, based on the information provided in the reports, the collection service is configured to identify a baseline of the types of interactions that occur during the normal operation of the computing environment. For example, in response to receiving reports from the agents, the collection service may generate an approved set of communication interactions based on the communication data of the reports. These approved communication interactions may identify the components involved in each of the communications, the type of communication format used for the communications, or any other relevant information. To determine the baseline for the computing environment, the collection service may employ a machine learning algorithm over a particular time period, receive reports over a particular user defined period, or may receive reports for any other period to generate the baseline.

Upon determination of the approved set of communication interactions, the collection service may receive additional reports that represent additional communication data for the application components. Once received, the collection service may identify a second set of interactions represented within the reports, and compare the second set of interactions to the approved set of interactions. Based on the comparison, a flagged set of communication interactions may be determined and presented to an administrator via a user interface. In at least one example, the administrator may be presented with a time period input parameter that allows the administrator to define a particular period of reports to be compared against the approved set of communication interactions. For example, the administrator may be interested in an hour, day, or minute long period provided by the communication reports.

In some implementations, in addition to the communication data, the agents for each of the application components may further collect and report information about processing data for each of the application components and any associated host computing systems. This processing data may include information about what processes are executing on the hosts, what packages are installed on the hosts, which of the applications are writing to disk, what types of data are being stored to disk, and other similar processing information for each of the application components and hosts. Once the information is gathered and transferred as reports to the collection service, the collection service may store the behavior information in one or more data structures, and use the behavior information from an approved time period to be compared against a second time period. For example, a particular set of processes may be executing on an application component during an approved time period. However, during a second time period, a second set of processes, different from the first, may be executing on the application component. This second set of processes may be compared against the first set of processes to notify an administrator of the current behavior state of the application component.

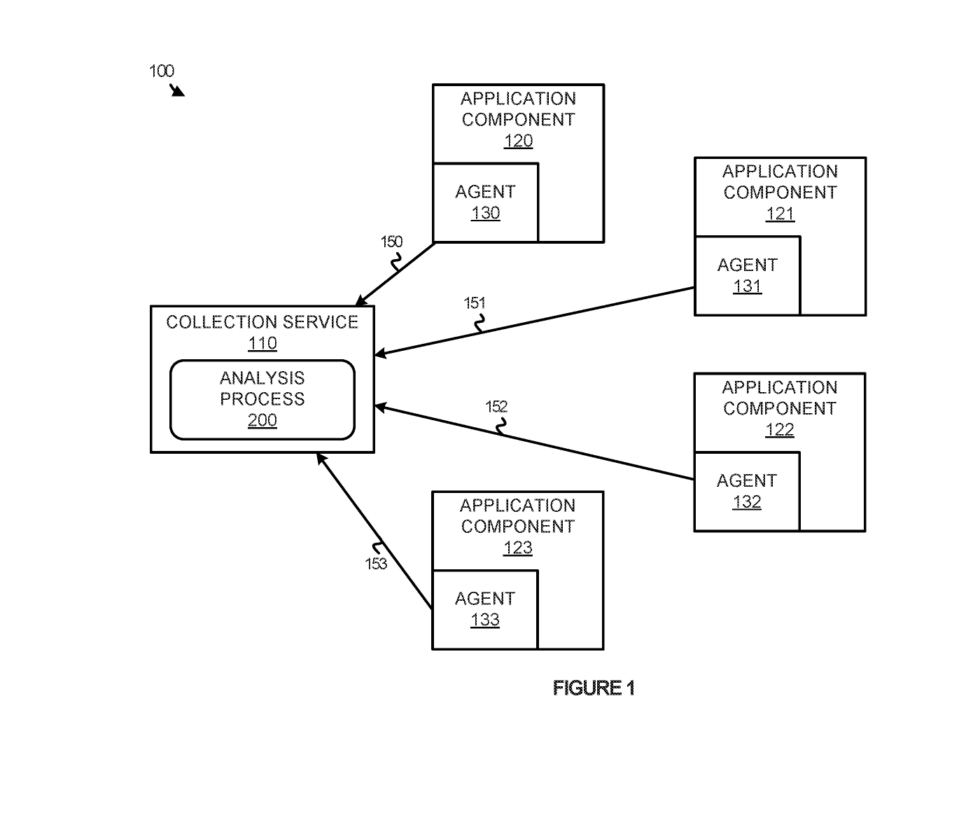

Referring now to FIG. 1, FIG. 1 illustrates a computing environment 100 for reporting communication information to a collection service. Computing environment 100 includes application components 120-123 and collection service 110. Application components 120-123 further include agents 130-133. Collection service 110 is configured to execute analysis process 200. Application components 120-123 communicate with collection service 110 via communication links 150-153.

Application components 120-123 may each comprise a Linux container, jail, partition, or other type of containment module, a full operating system virtual machine, or some other containment system, including combinations thereof. Application components 120-123 may execute via one or more host computing systems that may each include communication interfaces, network interfaces, processing systems, computer systems, microprocessors, storage systems, storage media, or some other processing devices or software systems, and can be distributed among multiple devices. In addition to or in place of the virtual components described above, in some examples, application components 120-123 may each comprise a physical computing system, such as a desktop or server computing system.

Collection service 110 may comprise a physical computing system, such as a desktop or serving computing system, and may also comprise a virtual node, such as a virtual machine or container, that executes via a host computing system. Collection service 110 may comprise communication interfaces, network interfaces, processing systems, computer systems, microprocessors, storage systems, storage media, or some other processing devices or software systems, and can be distributed among multiple devices.

Application components 120-123 communicate with collection service 110 via a plurality of communication links 150-153. These communication links may each use metal, glass, optical, air, space, or some other material as the transport media. Communication links 150-153 may use Time Division Multiplex (TDM), asynchronous transfer mode (ATM), IP, Ethernet, synchronous optical networking (SONET), hybrid fiber-coax (HFC), circuit-switched, communication signaling, wireless communications, or some other communication format, including improvements thereof. Communication links 150-153 may each be a direct link, or may include intermediate networks, systems, or devices, and may include a logical network link transported over multiple physical links

In operation, each of application components 120-123 may communicate data with the various other application components, as well as external computing devices and systems. For example, a first application component, which is a front-end service, may provide data to a second application component, which is a back-end service. To manage the various connections made between the application components of computing environment 100, collection service 110 is provided to maintain the communication and transaction information for the plurality of application components 120-123. This communication information may include data flow information, such as the devices or application components involved in each communication, the type of data included in each communication, the type of communication format used in the connection, such as HTTP or SSL, the amount of data communicated, the type of security used in the communication, amongst a variety of other communication information.

In some examples, to retrieve the communication information, application components 120-123 may transfer communication reports in a predefined format to collection service 110. These communication reports may be transferred after each communication, may be transferred periodically, such as every fifteen minutes or some other periodic time frame, may be transferred upon request of collection service 110, or transferred during a downtime for the application component or for the host system. Once a report is transferred from the agents associated with the application components, collection service 110 may organize the report into one or more data structures to assist in providing communication management to computing environment 100.

Although illustrated as located within the application components, it should be understood that agents 130-133 might reside on host computing systems providing the platform for application components 120-123. For example, if an application component comprises a virtual machine, the agent may operate within the kernel of the host system to determine the communication interactions for the application container. Thus, rather than having a single agent per application component, it should be understood that a single agent on a host computing system may manage the communication connections for a plurality of application components executing on the host.

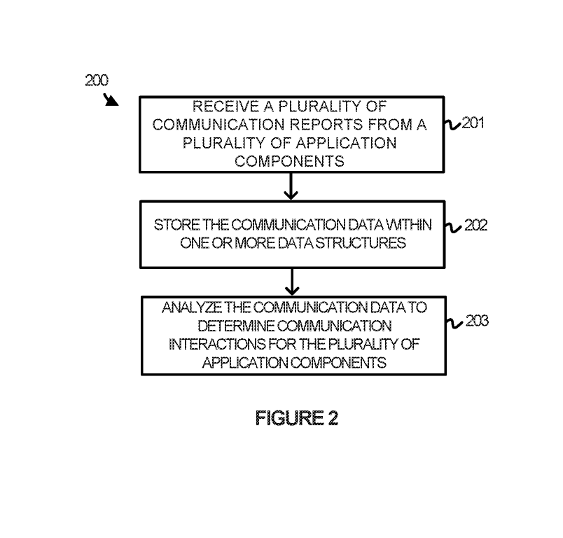

To further demonstrate the operation of collection service 110, FIG. 2 is provided. FIG. 2 illustrates an analysis process 200 to visually represent the communication interactions in computing environment 100. As described in FIG. 1, a computing environment may employ a plurality of application components, each configured to accomplish a particular task. For example, a first application component may comprise a front-end service, while a second application component may comprise a back-end service. Accordingly, to accomplish a desired functionality, the application components may require connections with one another, as well is with computing systems external to the computing environment. To maintain information about the various communications made by the application components, application components 120-123 are associated with agents 130-133. Agents 130-133, which may comprise operation monitoring software processes, identify information about the connections and communications made by the application components and provide the information to collection service 110. This information may include timestamp information for each communication, identifier information for the application components involved in each communication, data security information, such as SSL certificate information, for each communication, or content information, such as data packet total information or data sensitivity information, for each communication. Agents 130-133 may reside within the kernel of the computing system supporting application components 120-123, may reside as a process within application components 120-123, or may reside in any other location capable of identifying communication information and transferring the information as a communication report to collection service 110.

Analysis process 200 on collection service 110 includes receiving a plurality of communication reports representing communication data for communications by the plurality of application components 120-123 (201), and storing the communication data from the communication reports within one or more data structures (202). In some examples, storing the data within one or more data structures may comprise filtering the communication data in the communication reports using one or more communication filters. These filters may be able to identify communication data within the reports that relates to a particular communication characteristic. For example, the filters may be used to identify communications that relate to the netflow of data between the components within communication environment 100. Accordingly, if a communication occurred between an application component and a system external to environment 100, the filter may not identify this communication as part of the netflow for the environment, but would identify any communication between components 120-123. Once communication data is stored, analysis process 200 further analyzes the communication data to determine communication interactions for the plurality of application components (203).

In one example, the analyzing of the communication data may include determining baseline communication interactions for the application components. For instances, the baseline communication interactions may identify which components of components 120-123 are communicating over a particular testing time period, the type of communication protocol used between the components, as well as any other similar communication information. The testing time period may comprise a predefined testing time period, an administrator defined testing time period, or any other time period. In some implementations, rather than a time period, the baseline communication interactions may be learned by a machine learning algorithm, which can identify communications that are likely proper for the computing environment. Once the baseline communication interactions are identified, collection service 110 may receive supplemental communication reports with additional communication data. Based on the additional communication data, collection service 110 may determine second communication interactions for application components 120-123, and compare the interactions with the baseline interactions. Accordingly, if an interaction is identified in the second communication interactions, but is not included in the baseline communication interactions, the interaction may be flagged for further analysis or display to an administrator of the computing environment 100. In some examples, the display presented to the administrator may include a visual representation of the application components and may further include a visual representation of at least one flagged interaction. The display may further include communication traits for the flagged interaction including, but not limited to, the number of communications made between the two components in the interaction, the number of packets transferred between the components, the type of communication protocol involved in the flagged interaction, or the sensitivity of the data involved in the interaction.

In some implementations, in addition to the communication data, the reports from components 120-123 may include processing data for the application components and the associated host systems. Processing data may include information about what processes are executing on the hosts, what packages are installed on the hosts, which of the applications are writing to disk, what types of data are being stored to disk, and other similar processing information for each of the application components and associated hosts. Once the information is reported to collection service 110, collection service 110 may identify approved behavior for the environment using the reports, and compare the approved behavior to supplementary behavior for the environment to notify administrators of possible security threats in the environment. Accordingly, approved operational behavior for an environment may be compared with later operational behavior for the environment to determine the current behavior of the computing environment.

Although illustrated in the example of FIG. 1 as including four application components, it should be understood that any number of application components might be included within a communication environment. Further, although illustrated as located within each application component, it should be understood that in some examples agents 130-133 might be located within the kernel of their respective host computing systems. These agents may be installed on the computing systems when the machines are initiated, or may be dynamically added after the computing environment is operational.

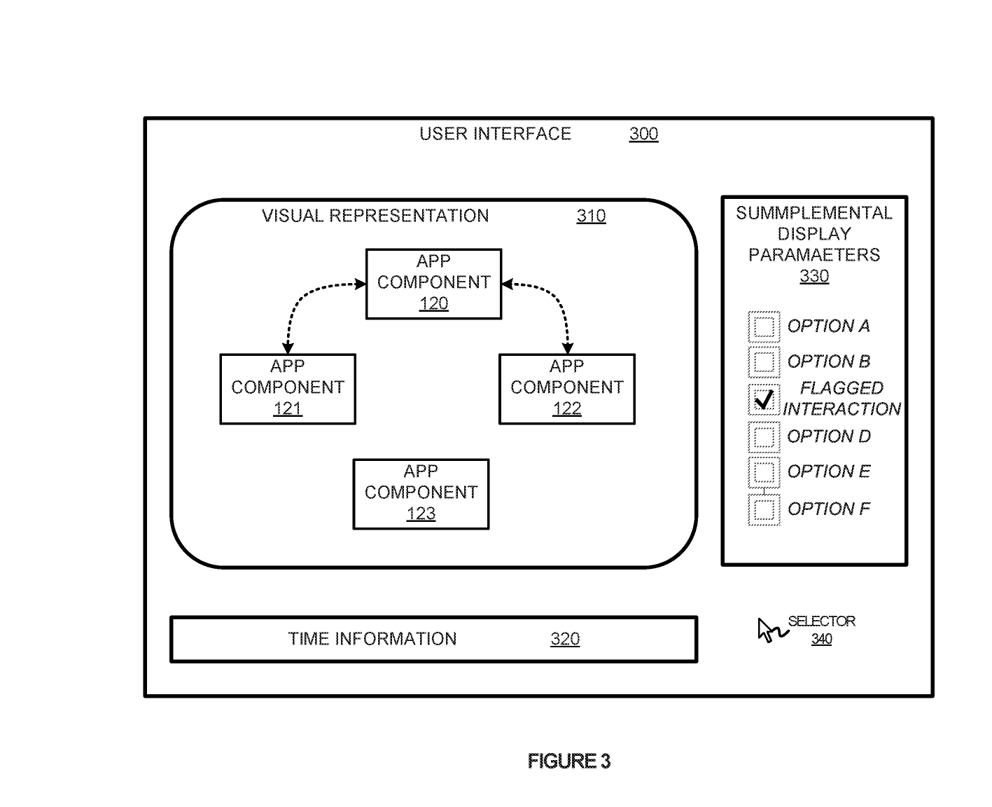

Turning to FIG. 3, FIG. 3 illustrates a user interface 300 to present a visual representation of computing environment 100. User interface 300 includes visual representation 310, time information 320, supplemental display parameters 330, and selector 340. User interface 300 is an example interface that may be generated by collection service 110 in FIG. 1, although other examples are possible. User interface 300 may be generated and displayed on the same computing system as collection service 110, or may be generated by collection service 110 and delivered to an end user device, such as a computer, mobile phone, tablet, or some other end user device.

As illustrated in the present example, visual representation 310 includes visual representations of application components 120-123. Further, user interface 300 allows a user or administrator to select time information 320, or a period of time for which communications and connections should be displayed. Time information 320 may comprise a time slider allowing the user to select the desired time period, a data entry box allowing the user to type or manually input the particular time period, or some other interface to define the desired time period. User interface 300 also allows a user to select particular supplemental display parameters 330 to filter or display particular traits of the communications between application components 120-123. Although illustrated with selector 340 in the present example to allow a user to select particular options within user interface 300, it should be understood that instead of a visual representation, such as a cursor, the user might use touch, voice, or some other interactive feature to select particular operations on user interface 300.

Here, the administrator selections within supplemental display parameters 330 include flagged interactions, or communication interactions that were not included within a baseline operation of computing environment 100. Based on the selections within supplemental display parameters 330 and time information 320, interactions are displayed in visual representation 310 that meet the defined criteria. As illustrated, the communications that meet the defined criteria includes communication interactions between application components 120 and 121, and further includes communication interactions between application components 120 and 122. While not illustrated in the present example, it should be understood that user interface 300 might also display communication traits for the communication interactions. These communication traits may include the number of communications made between the two application components, the number of data packets transferred between the application components, the communication format used in the communication interactions, or any other similar communication trait. These communication traits may be overlaid on top of visual representation 310 or may be included in a separate visual representation on user interface 300.

Although not illustrated in the present example, it should be understood that the visual interactions displayed in visual representation 310 may be color coded, assessed particular line patterns for the interactions, or given any other similar attributes to coordinate a particular parameter from display parameters 330 to the display on visual representation 310. For example, option C in display parameters 330 may be provided as a first color, whereas options E and F may be provided as second and third colors. This may assist the administrator in determining which interaction corresponds to which parameter in parameters 330.

Further, while not illustrated in the present example, it should be understood that the administrator might also desire to “zoom” or select particular portions of visual representation 310 to gather additional information about the communications. For instance, the administrator may select the communication interaction between application component 120 and application component 121 to gather more information about the one or more communications that occurred between the two components. This information may include the number of packets transferred between the components, the type of security that was used in the communication, the average packet length, the number of communications made, or any other similar information. Thus, by selecting the connectors, the administrator may be presented with a greater amount of detail about the particular interactions

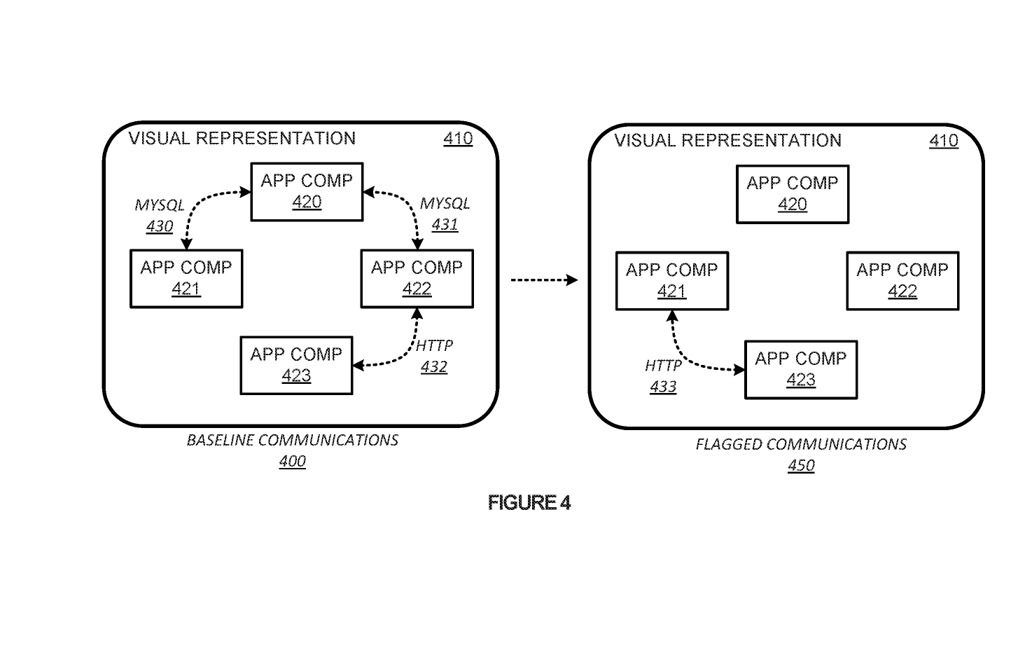

Turning to FIG. 4, FIG. 4 illustrates a visual representation 410 of communication interactions for a computing environment. Visual representation 410 includes visual representations of application components 420-423, and visual representations of communication interactions 430-433.

As depicted in baseline communications 400, visual representation 410 provides application component 420 communicating with application component 421 via communication interaction 430, application component 420 communicating with application component 422 via communication interaction 431, and application component 422 communicating with application component 423 via communication interaction 432. To determine baseline communications 400, a collection service may be configured to retrieve communication reports from the application components in a computing environment for a defined baseline time period. These reports may include a variety of communication data for the components, such as the application components or systems involved in each communication, the sensitivity of the data included in each communications, the amount of data packets transferred between the components, the communication protocol used between the components, or any other similar information. Once the information is received, baseline communication interactions may be defined for the computing environment based on the retrieved communication data. For example, the baseline interactions may be defined based on the identity of the components communicating, as well as the communication protocol used in the communications.

Once the baseline is determined for the computing environment, a collection service may receive additional communication reports from the system, and identify supplemental communication interactions based on the additional communication reports. The supplemental communication interactions may be compared with the baseline communication interactions to identify any discrepancies between the two sets of interactions. Here, as depicted in flagged communications 450, a visual representation may be generated based on the discrepancies between the baseline and the latter communication reports. In particular, visual representation 410 for flagged communications 450 includes application component 421 communicating with application component 423 via communication interaction 433.

By flagging the communication interactions that do not qualify for the baseline, an administrator may more quickly identify inappropriate interactions between components and external systems with the computing environment. For example, flagged communications 450 may be presented as a user interface to an administrative console. Once displayed, the administrator may select the particular interaction and implement security policy or communication policy changes for the involved application components. Referring to flagged communications 450, the administrator may define a firewall or some other security implementation for application components 420-423 to prevent future interactions. Further, the administrator may also be allowed to initiate analysis on the system to determine the process or processes that are responsible for initiating the communication interaction. In the alternative, the administrator may approve the flagged communication interactions if the communications are appropriate for the computing environment. Thus, once approved, communication interaction 433 may be added to baseline interactions for future analysis of received communication reports.

In some implementations, the communication interactions for a computing environment may be defined at a service group level. These service groups may include a front-end service level, a back-end service level, a database service level, or any other similar service level that represents the one or more components that provide a particular service. For example, an organization may employ three front-end service components in some examples. Rather than defining the communication interactions individually for the components, the communication interactions may be defined as a group, which can be analyzed and presented to the administrator of the environment. Thus, an administrator of the network may define multiple components as a single grouped component based on the service that the components provide in the environment.

Although illustrated in the example of FIG. 4 with communication data, it should be understood that similar operations may be used with processing data for the application containers and associated host systems. For instance, in addition to or in place of the communication data, a visual representation may be generated that displays baseline and/or flagged behavior within the application components. This visual representation may comprise a list of the processing data for the application containers and the hosts, may comprise a visual representation of the application containers in the environment, or may comprise any other similar visual representation.

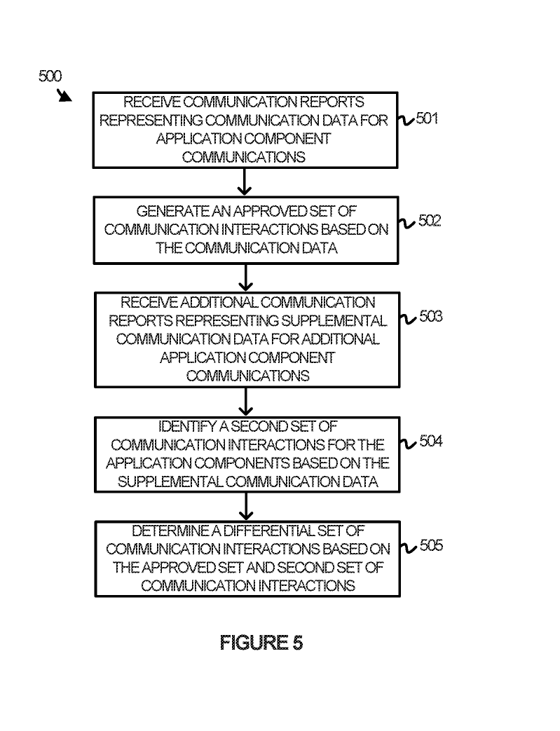

Referring now to FIG. 5, FIG. 5 illustrates a method 500 of operating a collection service to identify a differential set of communication interactions for a computing environment. As depicted, method 500 includes receiving communication reports representing communication data for application component communications (501). As described herein, a plurality of application components may be deployed in a computing environment to provide a variety of services, such as front-end services, back-end services, data analysis services, or any other similar service. In conjunction with the application components, agents may be deployed that identify the communications for each of the application components, and report the data of the communications as communication reports to the collection service. Upon receipt of the plurality of communication reports, the collection service generates an approved set of communication interactions based on the communication data (502).

In some examples, an administrator may initiate the generation of a baseline for communications in the computing environment. This baseline operation of the computing environment may include receiving communication reports for a predefined or user defined period, and identifying an approved set of communication interactions during the time period. In some examples, the set of communication interactions may be based on communication data, such as the application component involved in each communication, the communication protocol used for each communication, or any other similar communication data.

Once the approved set of communication interactions is determined, the method further provides receiving one or more additional communication reports representing supplemental communication data for additional application component communications (503). Upon receipt of the one or more additional communication reports, the collection service identifies a second set of communication interactions for the application components based on the supplemental communication data (504). In response to identifying the second set of communication interactions, the collection service identifies or determines a differential set of communication interactions based on the approved set and the second set of communication interactions (505).

As described previously, communication interactions may be defined by the application components involved, as well as the communication format used between the application components. Accordingly, if the collection service identifies a new communication interaction in the second set of communication interactions that is not included in the approved set of communication interactions, the new communication interaction may be flagged and placed in a differential set of communication interactions. This differential set of communication interactions may then be provided to an administrator, allowing the administrator to view the flagged interactions. In some examples, the differential communication interactions may be presented as a list to the administrator, however, in other instances, the differential communication interactions may be presented to the administrator as a visual representation of the computing environment, similar to the visual representations depicted in FIG. 3 and FIG. 4. Once presented to the administrator, the administrator may select one or more of the interactions to identify further characteristics about each of the communications, select the communication interaction to implement a new security process within the environment, select the communication interaction to approve the interaction or add the interaction to the approved set of communication interactions, or provide any other similar input.

In some examples, in addition to providing an illustration of the differential set of communication interactions, the user interface may also allow the administrator to identify a particular relevant time period for the computing environment. Accordingly, rather than displaying the communication interactions for all of time, the display of the differential set of communication interactions may only include interactions that occurred during the user defined time period.

In some implementations, components may be grouped into service groups. For example, a plurality of computing systems may be used to provide front-end service for an organization. Accordingly, rather than displaying each of the components in the back-end service separately, the components may be grouped together and displayed as a single “back-end” service component for the administrator. To define the functions of the components and service groups within the environment, an administrator may classify each of the components as they are added to the network. Accordingly, each component may be classified as a front-end service component, a back-end service component, a database service component, or some other service component within the environment. Based on the classifications, the individual components may be grouped with similar components within the environment.

In some implementations, in addition to the communication data for the application components, the reports from the agents may include processing data for the application components and associated host systems. This processing data may include information about what processes are executing on the hosts, what packages are installed on the hosts, which of the applications are writing to disk, what types of data are being stored to disk, and other similar processing information for each of the application components and associated hosts. The processing data may be used to generate an approved set of behavior for the computing environment, which may be compared to information from alter reports to flag possible unapproved behavior. For example, if a new process were executing on an application container that was not identified in the approved behavior, the new process may be flagged and displayed for an administrator of the computing environment.

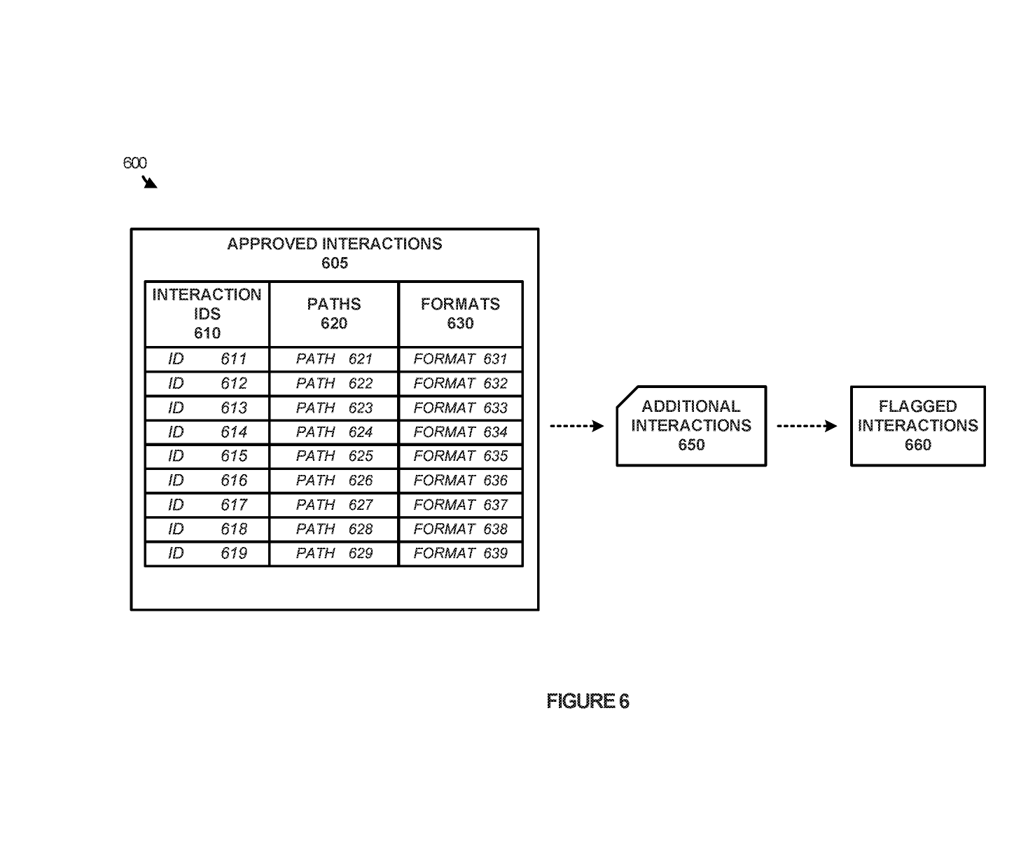

To further demonstrate comparing approved communication interactions with secondary communication interactions, FIG. 6 is provided. FIG. 6 illustrates an overview 600 of comparing approved communication interactions with secondary communication interactions according to one example. Overview 600 includes approved interactions 605, additional interactions 650, and flagged interactions 660. Approved interactions 605 further include interaction identifiers (IDs) 610 with IDs 611-619, paths 620 with individual paths 621-629, and formats 630 comprising formats 631-639. Although not illustrated in the present example, it should be understood that additional interactions 650 and flagged interactions 660 include similar categories to approved interactions 605.

As described herein, a baseline of approved communication interactions may be determined by a collection service for a computing environment based on reports received from agents associated with application components. These reports may include communication data such as identifiers for the components involved in the communications, the communication format used in the communication, the amount of data communicated, the sensitivity of the data communicated, or any other similar communication data. Once the communication data is retrieved for the baseline, a set of approved interactions 605 may be generated for the computing environment. In the present example, approved interactions 605 include interaction IDs 611-619, paths 621-629, and formats 631-639. Although illustrated with nine interactions in the present example, it should be understood that the set of approved communication interactions might include any number of interactions. Further, although two data columns are used to define the approved communication interactions, it should be understood that any number of data columns may be used to classify the communication interactions. For example, interactions may further be classified based on the sensitivity of the data being transferred, or some other data classification.

Once approved interactions 605 are determined, the collection service may receive one or more additional reports corresponding to supplemental communication data for that application components. Upon receipt of the additional reports, additional interactions 650 may be generated based on the data in the additional reports. Additional interactions 650 may then be compared against approved interactions 605 to determine if any discrepancies exist. If discrepancies do not exist then none of the interactions will be flagged from additional interactions 650. However, if a discrepancy is found between approved interactions 605 and additional interactions 650, the interaction in additional interactions 650 with the discrepancy will be added to flagged interactions 660.

As interactions are added to flagged interactions 660, flagged interactions 660 may be displayed to an administrator of the computing environment. This display may comprise a list or table of the identified interactions, or may comprise a visual representation of the computing environment including the visual representations of the application components and visual representations or visual connectors between the application components representing the interactions. In some examples, in addition to the visual connectors, the display provided to the administrator may also include communication traits associated with the flagged interactions. These communication traits may include the communication format that is used for each communication interaction, the total amount of data transferred for the communications represented by each communication interaction, the sensitivity of the data transferred for each interaction, or any other similar characteristic.

In some instances, the user interface provided to the administrator may allow the administrator to select a particular period of time for flagged interactions 660. Accordingly, rather than displaying all of the interactions within flagged interactions 660, only the interactions that occurred within the time period will be displayed for the user.

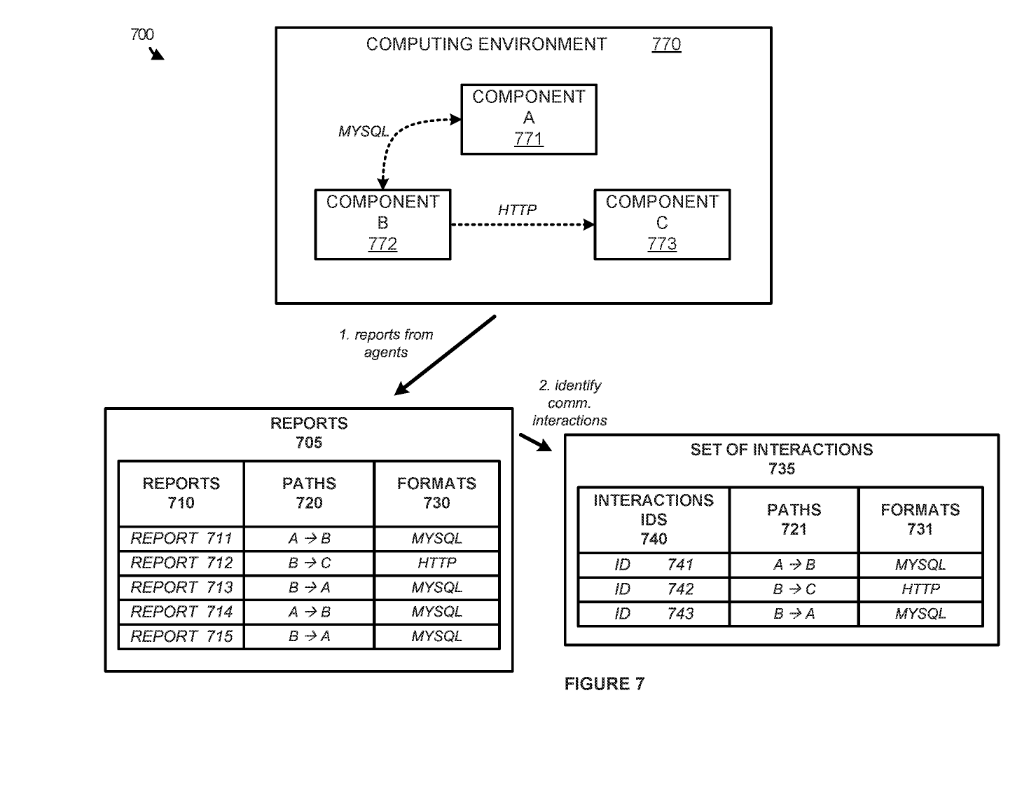

Turning to FIG. 7, FIG. 7 illustrates an overview 700 of generating communication interaction sets for a computing environment according to one example. Overview 700 includes computing environment 770, reports 705, and set of interactions 735. Overview 700 is an example of generating a baseline or approved set of communication interactions, or a second set of communication interactions to compare against an approved set of communication interactions.

As illustrated in the present example, computing environment 770 includes three application components 771-773 that communicate various data within the environment. Specifically, application components 771-772 communicate using MySQL, and component B 772 communicates data to component C 773 using HTTP. As the communications occur, one or more agents associated with application components 771-773 identify communication data and transfer the communication data to a collection service in the form of communication reports. This communication data may include identifiers for the application components or external systems involved in each communications, the type of communication format involved in each communication, the amount of data transferred in the communication, the sensitivity of the data transferred in each communication, or any other similar information.

Here, reports 711-715 are transferred to the collection service and include at least identifiers for the components involved in each of the communications, illustrated as paths 720 in reports 705, and further include the communication format for each communication illustrated as formats 730 in reports 705. Once the reports are received by the collection service, the collection service may generate a set of interactions 735 based on reports 705. To generate the set of interactions 735, the information in the reports is summarized to eliminate duplicate interactions. For example report 714 is not required because it provides the same information as report 711. However, if reports 705 included a field for the total number of packets transferred, then the number of packets transferred from reports 714 could be summed with the information in report 711.

As the reports are received, interaction identifiers (IDs) 740 are created for each of the interactions, and paths 721 and formats 731 are maintained for each of the identified interactions. Once the set of interactions is generated, the set may be used to provide an administrator with insight into the communications occurring within computing environment 770. For example, set of interactions 735 may comprise a baseline set of interactions that can be compared to secondary data received from subsequent communication reports. Accordingly, if a subsequent report includes a communication, such as component C 773 communicating with component A 771 via FTP, then the user may flag this communication interaction for future analysis or display to an administrator.

In some implementations, multiple application components may be used to provide a particular service in a computing environment. As a result, rather than generating a set of interactions representing interactions between each component, the components may be grouped as service groups. For example, all components that provide a front-end service may be grouped within a service group. Once associated with one another, the set of interactions may analyze the communication data for the group as a whole. Consequently, if any of the front-end components communicated with a database component in the environment, the entire service group may be classified as communicating with that database component. By combining like components, an administrator may more easily identify interactions that are improper within the environment by limiting the number of components that are displayed for the user. However, if necessary, the user may zoom into a particular service group to analyze the data interactions between each of the components in the group.

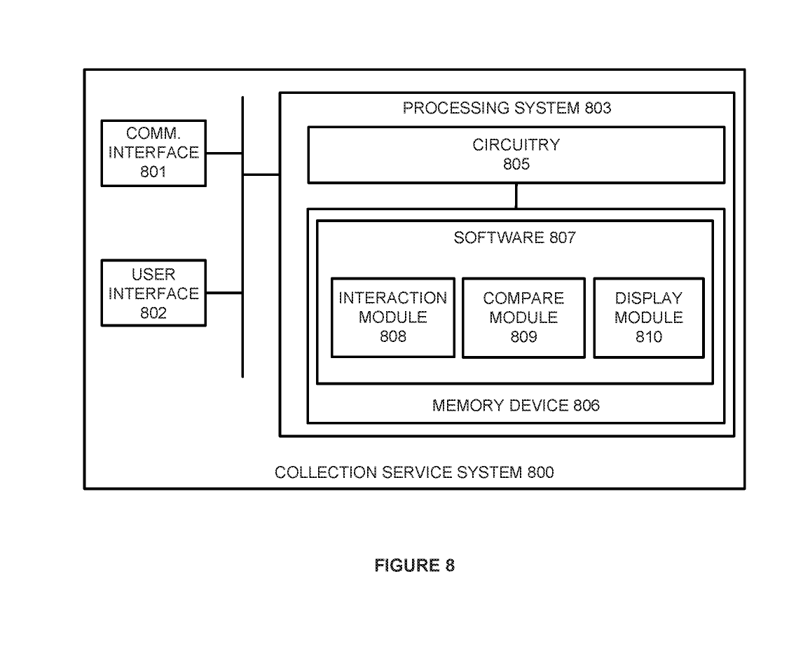

FIG. 8 illustrates a collection service system 800 that is representative of any computing system or systems with which the various operational architectures, processes, scenarios, and sequences disclosed herein for a collection service may be implemented. Collection service system 800 is an example of collection service nodes 110, 510, and 710, although other examples may exist. Collection service system 800 comprises communication interface 801, user interface 802, and processing system 803. Processing system 803 is linked to communication interface 801 and user interface 802. Processing system 803 includes processing circuitry 805 and memory device 806 that stores operating software 807. Collection service system 800 may include other well-known components such as a battery and enclosure that are not shown for clarity. Collection service system 800 may be a personal computer, server, or some other computing apparatus—including combinations thereof.

Communication interface 801 comprises components that communicate over communication links, such as network cards, ports, RF transceivers, processing circuitry and software, or some other communication devices. Communication interface 801 may be configured to communicate over metallic, wireless, or optical links Communication interface 801 may be configured to use Time Division Multiplex (TDM), Internet Protocol (IP), Ethernet, optical networking, wireless protocols, communication signaling, or some other communication format—including combinations thereof. Specifically, communication interface 801 may communicate with one or more other computing systems to gather communication reports for a plurality of application components. Further, in some examples, communication interface 801 may communicate with one or more console devices to provide information about the application components that can be displayed to an administrator of the components.

User interface 802 comprises components that interact with a user to receive user inputs and to present media and/or information. User interface 802 may include a speaker, microphone, buttons, lights, display screen, touch screen, touch pad, scroll wheel, communication port, or some other user input/output apparatus—including combinations thereof. In some instances, user interface 802 may be used to receive user input regarding display parameters related to the communication data gathered for the plurality of application components. In some examples, user interface 802 may allow an examiner to implement security updates for the various application components within the computing environment. User interface 802 may be omitted in some examples.

Processing circuitry 805 comprises microprocessor and other circuitry that retrieves and executes operating software 807 from memory device 806. Memory device 806 comprises a non-transitory storage medium, such as a disk drive, flash drive, data storage circuitry, or some other memory apparatus. Processing circuitry 805 is typically mounted on a circuit board that may also hold memory device 806 and portions of communication interface 801 and user interface 802. Operating software 807 comprises computer programs, firmware, or some other form of machine-readable processing instructions. Operating software 807 includes interaction module 808, compare module 809, and display module 810, although any number of software modules may provide the same operation. Operating software 807 may further include an operating system, utilities, drivers, network interfaces, applications, or some other type of software. When executed by processing circuitry 805, operating software 807 directs processing system 803 to operate collection service system 800 as described herein.

In particular, operating software 807 directs processing system 803 to receive a plurality of communication reports representing communication data for communications by a plurality of application components. Once received, interaction module 808 directs processing system 803 to generate an approved set of communication interactions for the plurality of application components based on the communication data. In some examples, an administrator may initiate a baseline testing process on the plurality of application components to determine communication interactions within the environment. As reports are received during the testing process, a set of approved communication interactions may be generated. In some examples, once the set of approved communication interactions are determined, the interactions may be provided to an administrator, allowing the administrator to review the communications and approve or reject communications to be included in the set of approved communication interactions.

Once the approved set of communication interactions is determined, operating software 807 directs processing system 803 to receive additional communication reports representing supplemental communication data for additional application component communications. Upon receipt of the additional communication reports, interaction module 808 directs processing system 803 to generate a second set of communication interactions for the plurality of application components. Once generated, compare module 809 directs processing system 803 to determine a differential set of communication interactions based on the approved set and the second set of communication interactions. For example, the second set of communication interactions may include a communication between two application components that was not provided in the approved set of communication interactions. Accordingly, this communication may be flagged for further analysis or provided to an administrator of the computing environment.

As illustrated in the present example, a display module, such as display module 810, may be included that directs processing system 803 to generate a display based on the differential set of communication interactions. This display may include a list of the differential set of communications, or may comprise a visual representation of the computing environment. For example, the display may include a visual representation of the application components, and may further include one or more visual links representing the differential set of communication interactions. Further, the display may display communication traits associated with each of the communication interactions, such as the communication protocol used for the interaction, the amount of data transferred, the sensitivity of the data transferred, or any other similar communication trait. In some examples, in addition to the visual representation of the differential set of communication interactions, one or more visual links may also be provided to demonstrate the approved interactions of the application components. Thus, the visual links for the differential interactions may be made a different color, a different pattern, or any other distinguishing feature to distinguish the differential set from the approved set of communication interactions.

In some instances, display module 810 may allow the administrator to interact with or provide feedback regarding the display of the application components. For example, the administrator may be allowed to add communication interactions from the differential set to the approved set. In another example, the user may select a displayed interaction from the differential set, and implement a new security function to prevent future communications between the same components. This may include implementing a firewall configuration for the components, implementing an encryption configuration for the components, or any other similar security function.

In some implementations, in addition to the communication data, the reports may provide processing data for the application containers and the associated host computing systems. This processing data may include information about what processes are executing on the hosts, what packages are installed on the hosts, which of the applications are writing to disk, what types of data are being stored to disk, and other similar processing information for each of the application components and hosts. Based on the information provided in the reports, collection service system 800 may identify approved behavior for the hosts and application containers, identify secondary behavior for the hosts and application containers, and compare the behavior to identify potential threats within the environment. For example, a first set of reports may identify a set of approved processes executing on the host computing systems. Once the approved processes are determined, a second set of reports may identify a second set of processes executing on the host computing systems. The second set of processes may then be compared against the approved processes to identify if any processes have not been approved.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A computer readable storage medium having instructions stored thereon that, when executed by a collection service system, direct the collection service system to perform a method of identifying unverified behavior in a computing environment, the method comprising:
receiving a plurality of reports representing communication data for communications by a plurality of application components;
generating an approved set of communication interactions for the plurality of application components based on the communication data;
receiving one or more additional reports representing supplemental communication data for additional communications by the plurality of application components;
identifying a second set of communication interactions for the plurality of application components based on the supplemental communication data; and
determining a differential set of communication interactions by comparing the approved set of communication interactions and the second set of communication interactions.

2. The computer readable storage medium of claim 1, wherein the method further comprises generating a display based on the differential set of communication interactions.

3. The computer readable storage medium of claim 2, wherein the display comprises a visual representation of the plurality of application components and a visual representation of at least one communication interaction in the differential set of communication interactions.

4. The computer readable storage medium of claim 3, wherein the display further comprises communication traits for the at least one communication interaction in the differential set of communication interactions.

5. The computer readable storage medium of claim 1, wherein the reports further represent processing data for the plurality of application components and any host computing systems associated with the plurality of application components, wherein the additional reports further represent supplemental processing data for the plurality of application components and any host computing systems associated with the plurality of application components, and wherein the method further comprises:
generating an approved set of processing operations for the plurality of application components based on the processing data;
identifying a second set of processing operations for the plurality of application components based on the supplemental processing data; and
determining a differential set of processing operations by comparing the approved set of processing operations and the second set of processing operations.

6. The computer readable storage medium of claim 5, wherein the processing data and the supplemental processing data comprises at least one of information for what processes are executing on each host computing system, what packages are installed on each host computing system, or what applications are writing to disk on each host computing system.

7. The computer readable storage medium of claim 1, wherein the communication data and supplemental communication data comprises communication path information for each communication and communication protocol information for each communication.

8. The computer readable storage medium of claim 1, wherein receiving the plurality of reports representing the communication data for the communications by the plurality of application components comprises receiving the plurality of reports representing the communication data for the communications by the plurality of application components for a predefined time period.

9. A method of operating a collection service to identify unverified behavior for a plurality of application components, the method comprising:
receiving a plurality of reports representing communication data for communications by the plurality of application components;
generating an approved set of communication interactions for the plurality of application components based on the communication data;
receiving one or more additional reports representing supplemental communication data for additional communications by the plurality of application components;
identifying a second set of communication interactions for the plurality of application components based on the supplemental communication data; and
determining a differential set of communication interactions by comparing the approved set of communication interactions and the second set of communication interactions.

10. The method of claim 9 further comprising generating a display based on the differential set of communication interactions.

11. The method of claim 10 wherein the display comprises a visual representation of the plurality of application components and a visual representation of at least one communication interaction in the differential set of communication interactions.

12. The method of claim 11 wherein the display further comprises communication traits for the at least one communication interaction in the differential set of communication interactions.

13. The method of claim 9 wherein the reports further represent processing data for the plurality of application components and any host computing systems associated with the plurality of application components, wherein the additional reports further represent supplemental processing data for the plurality of application components and any host computing systems associated with the plurality of application components, and wherein the method further comprises:
generating an approved set of processing operations for the plurality of application components based on the processing data;
identifying a second set of processing operations for the plurality of application components based on the supplemental processing data; and
determining a differential set of processing operations by comparing the approved set of processing operations and the second set of processing operations.

14. The method of claim 13 wherein the processing data and the supplemental processing data comprises at least one of information for what processes are executing on each host computing system, what packages are installed on each host computing system, or what applications are writing to disk on each host computing system.

15. The method of claim 9 wherein the communication data and the supplemental communication data comprises communication path information for each communication and communication protocol information for each communication.

16. The method of claim 9 wherein receiving the plurality of reports representing the communication data for the communications by the plurality of application components comprises receiving the plurality of reports representing the communication data for the communications by the plurality of application components for a predefined time period.

17. A method of operating a collection service to identify unverified behavior in a computing environment, the method comprising:
receiving a plurality of reports from agents in the computing environment, wherein the plurality of reports comprise communication data and processing data for application components and host computing systems in the computing environment;
generating an approved set of behavior operations based on the reports;
receiving one or more additional reports from the agents in the computing environment, wherein the one or more additional reports comprise supplemental communication data and supplemental processing data for the application components and the host computing systems in the computing environment;
identifying a second set of behavior operations based on the additional reports; and
determining a differential set of behavior operations by comparing the approved set of behavior operations and the second set of behavior operations.

18. The method of claim 17 wherein the communication data and the supplemental communication data comprises communication path information for communications by application components and communication protocol information for communications by the application components.

19. The method of claim 17 wherein the processing data and the supplemental processing data comprises at least one of information for what processes are executing on each host computing system, what packages are installed on each host computing system, or what applications are writing to disk on each host computing system.

20. The method of claim 17 wherein receiving the plurality of reports from the agents in the computing environment comprises receiving, for an administrator defined time period, the plurality of reports from the agents in the computing environment.
